(19) United States
(12) Patent Application Publication
(10) Pub. No.: US 2013/0325595 A1
(43) Pub. Date: Dec. 5, 2013

(54) SOCIAL MEDIA MARKETING AND PROCEED DISTRIBUTION METHOD AND SYSTEM THEREOF

(71) Applicant: Mehmet Ali Ilicak, Istanbul (TR)

(72) Inventor: Mehmet Ali Ilicak, Istanbul (TR)

(21) Appl. No.: 13/904,551

(22) Filed: May 29, 2013

Related U.S. Application Data
(60) Provisional application No. 61/652,488, filed on May 29, 2012.

(51) Int. Cl. G06Q 30/02

(52) U.S. Cl. CPC G06Q 30/0247; G06Q 30/0274
USPC 705/14.46

(57) ABSTRACT

A method comprising registering a first user based on a request to join a host company network, determining a level of the first user within a structure of the host company network, registering a second user with the host company network, based on an invitation from the first user to join the host company network, wherein a level of the second user in the structure is different than the level of the first user, tracking a gross amount of proceeds generated by a sale of a product advertised on a social media platform of the first user and a social media platform of the second user; and distributing a remaining amount of proceeds to the first user and the second user in accordance with the level of the first user and the level of the second user within the structure is provided. Furthermore, an associated system is also provided.

### CROSS-REFERENCE TO RELATED APPLICATIONS

This application claims priority to U.S. Provisional Application No. 61/652,488, filed May 29, 2012, and entitled, “Social Media Marketing and Proceed Distribution Method and System.”

### FIELD OF TECHNOLOGY

The following relates to an intermediary e-commerce platform and more specifically to embodiments of a system and method of social media networking sales and proceed distribution.

### BACKGROUND

Social media and social networks are an increasingly popular form of communication. For instance, a member or user creates a webpage that is interconnected with other users, and can be accessed by the public or by approved users of the social network or social media. Online advertising is prevalent on the social media and social networking sites, including the members' individual pages. Sales generated by the online advertising benefit the company paying for the advertisement, and the owner of the social media or social media website. Because the advertisements are placed on the personal pages of the users, the users or members of the social network are essentially selling the product or service being advertised when they connect and interact with other users. However, the individual members of the social media or social network sites do not receive any compensation.

Thus, a need exists for a system and method of proceed distribution to active users to allow for compensation to the users or members of social media and social networking.

### SUMMARY

A first aspect relates generally to a method comprising: registering, by a processor of a computing system, a first user based on a request to join a host company network; determining, by the processor of the computing system, a level of the first user within a structure of the host company network; registering, by the processor of the computing system, a second user with the host company network, based on an invitation from the first user to the second user to join the host company network, wherein a level of the second user in the structure is different than the level of the first user; tracking, by the processor of the computing system, a gross amount of proceeds generated by a sale of a product advertised on a social media platform of the first user and a social media platform of the second user; and distributing, by the processor of the computing system, a remaining amount of proceeds to the first user and the second user in accordance with the level of the first user and the level of the second user within the structure.

A second aspect relates generally to a method of social networking advertising and proceed distribution comprising: establishing an online retail store operated by a host company network, the host company network implemented by a processor of a computing system; receiving, by the processor of the computing system, a request for membership to join the host company network from a plurality of users; in response to receiving the request, determining, by the processor of the computing system, a level of membership of the plurality of users within one or more structures; placing, by the processor of a computing system, an online advertisement of a product being sold on the online retail store operated by the host company network on a social networking platform of one or more of the plurality of users; and distributing, by the processor of a computing system, an amount of proceeds to one or more users of the plurality of users in response to a sale of the product at the online retail store of the host company network.

A third general aspect relates to a computing system comprising a computer processor coupled to a computer-readable storage device, said storage device containing instructions that when executed by the processor implements a method comprising: registering, by a processor of a computing system, a first user based on a request to join a host company network; determining, by the processor of the computing system, a level of the first user within a structure of the host company network; registering, by the processor of the computing system, a second user with the host company network, based on an invitation from the first user to the second user to join the host company network, wherein a level of the second user within the structure is below the level of the first user; tracking, by the processor of the computing system, a gross amount of proceeds generated by a sale of a product advertised on a social media platform of the first user and a social media platform of the second user; and distributing, by the processor of the computing system, a remaining amount of proceeds to the first user and the second user in accordance with the level of the first user and the level of the second user within the structure.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1A depicts a flowchart of a first embodiment of a method of social networking advertising and proceeds distribution;

FIG. 1B depicts a flowchart of a second embodiment of a method of social media networking advertising and proceed distribution;

FIG. 2 depicts an embodiment of a system including a host company network;

FIG. 3 depicts an embodiment of a system that is used with the method of social networking advertising and proceed distribution; and

FIG. 4 depicts a schematic view of an embodiment of a computer system.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it can be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it can be noted that, as used in this specification and the appended claims, the singular forms “a”, “an” and “the” include plural referents, unless the context clearly dictates otherwise.

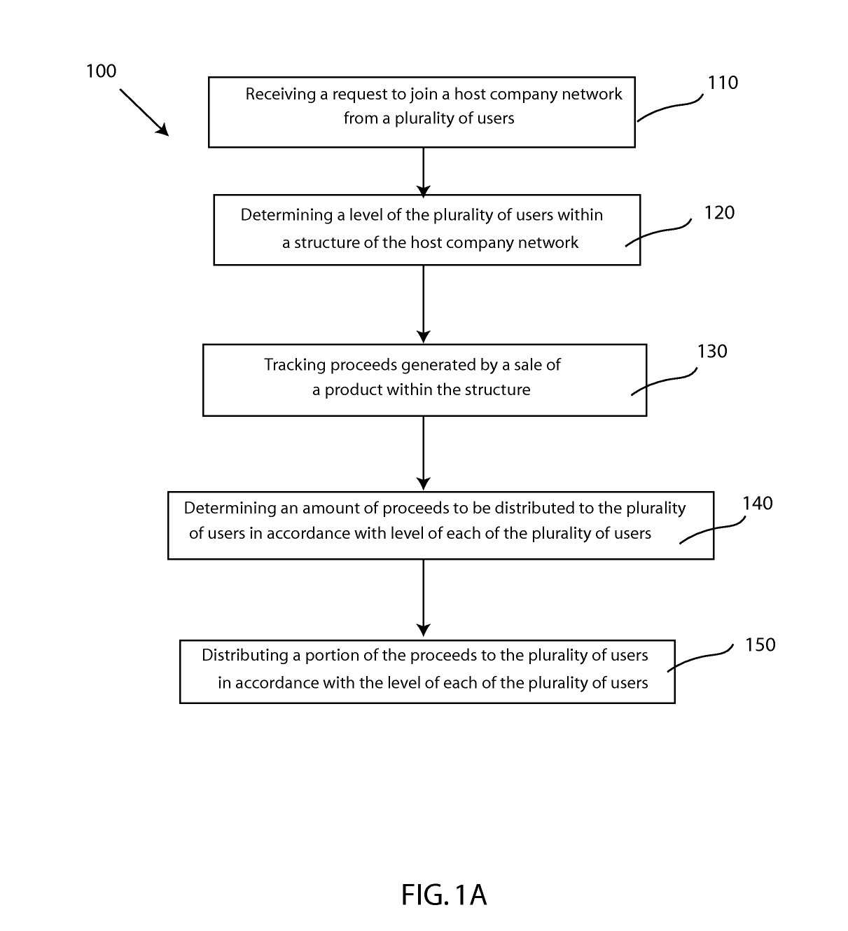

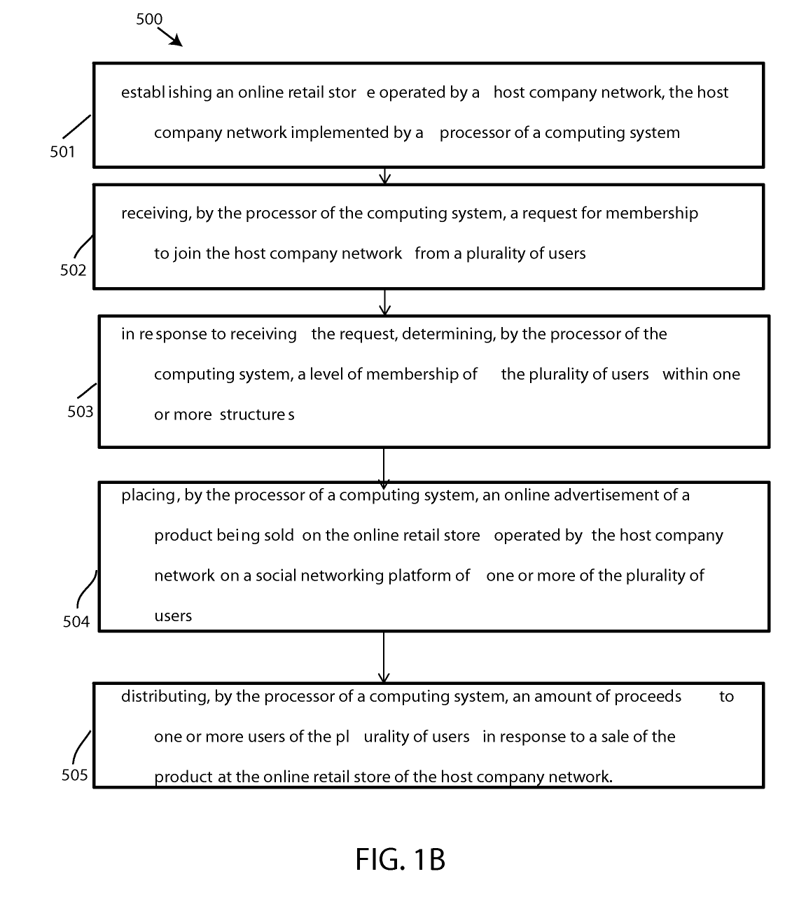

Referring to the drawings, FIG. 1A depicts an embodiment of a method of social networking advertising and proceed distribution to a plurality of interconnected users, a host company, and a seller of a product 100. Embodiments of the method 100 may include the steps of receiving, by a processor of a computing system 10, a request to join a host company network from one or more of a plurality of users 110, determining, by the processor of the computing system 10, a level of a user of the plurality of users within a structure of the host company network 120, tracking, by the processor, proceeds generated by a sale of a product within a structure 130, wherein the structure includes a first level, a second level, a third level, and a fourth level, determining, by the processor, an amount of proceeds to be distributed to the one or users of the plurality of users in accordance with the level of each of the plurality of members 140, and distributing, by the processor, a portion of proceeds to the plurality of users in accordance with the level of each of the plurality of users 150. Embodiments of method 100 may include the step of distributing at least some amount of the total proceeds from the sale of the product to each of the plurality of users, or a user or group of users connected with a sale through the host company network. Furthermore, embodiments of the step of determining an amount of proceeds to be distributed to the plurality of users may be performed after an initial portion of the total proceeds are distributed to the host company and the seller of the product. Embodiments of method 100 may incorporate steps and/or limitations from the following description.

FIG. 1B depicts another embodiment of a method 500. Embodiments of method 200 may include the steps of establishing an online retail store operated by a host company network, the host company network implemented by a processor of a computing system 501, receiving, by the processor of the computing system, a request for membership to join the host company network from a plurality of users 502, in response to receiving the request, determining, by the processor of the computing system, a level of membership of the plurality of users within one or more structures 503, placing, by the processor of a computing system, an online advertisement of a product being sold on the online retail store operated by the host company network on a social networking platform of one or more of the plurality of users 504, and distributing, by the processor of a computing system, an amount of proceeds to one or more users of the plurality of users in response to a sale of the product at the online retail store of the host company network 505.

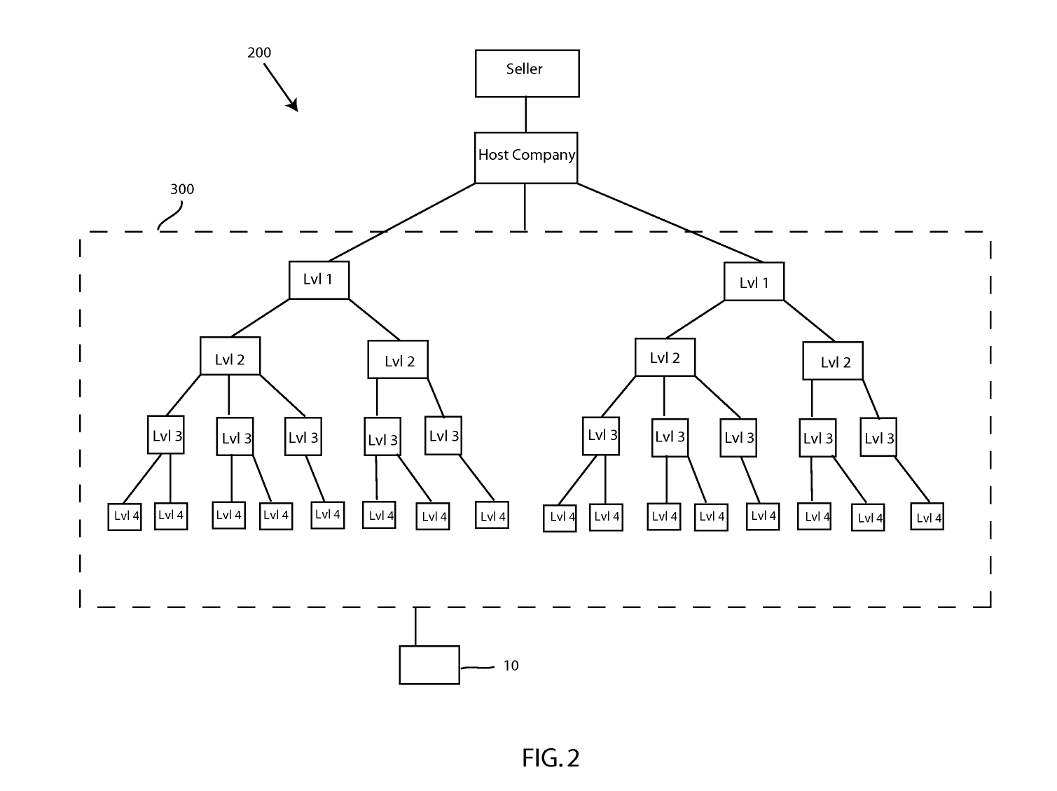

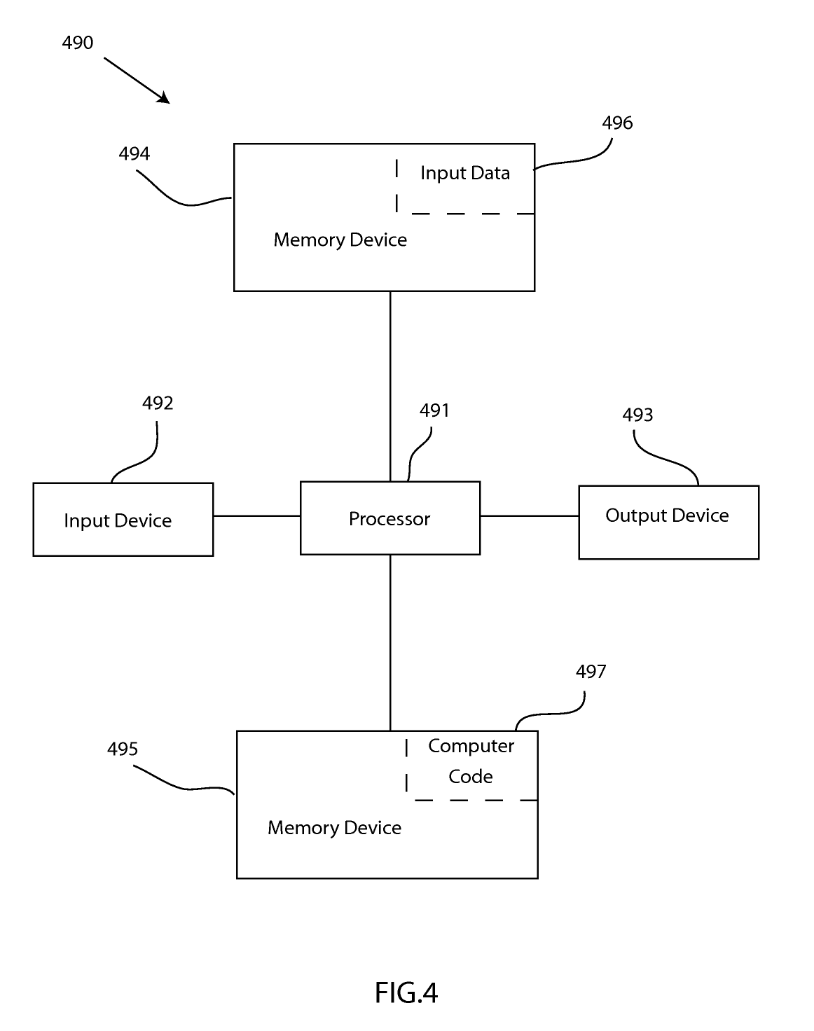

With reference to FIG. 2, embodiments of system 200 may be a system in accordance with method 100, 500. Embodiments of system 200 may include a host company, a seller of a product, and a plurality of interconnected users. The host company may operate, via a computing system connected to a plurality of user interfaces and electronic devices over a network (as shown in FIG. 4), a host company network, such as a website, that allows multiple users to join and participate in the system 200. Embodiments of a seller may be a company or individual offering for sale a good or service through the host company network, wherein the seller cooperates with the host company to sell and/or advertise a product (or service) through the plurality of users subscribed to the host company network. The plurality of members may be individuals or entities that utilize their personal platforms, such as “pages” or “walls”, of a social media networking website to display, sell, advertise, etc. the product offered by the seller through the host company network. Embodiments of system 200 may be an intermediary e-commerce platform, wherein steps of the method 100, 500 may be implemented by a processor of a computing system 10. Anyone of the interconnected users involved and present in the system 200 may earn a certain amount of money to the extent that products are sold in connection with the host company, such as through a website of the host company. Embodiments of system 200 may provide products meeting required criteria by bringing together interconnected members, such as people or firms, and implementing e-commerce business via social media networking websites. The interconnected members may share products in all channels they use and invite their friends to expand a network. Implementing the system 200 through execution of the method 100, 500 may allow for all parties, such as interconnected members, intermediary organizations, and a host company to obtain a specific profit in return for sharing, selling, displaying, expanding the network by inviting additional members, and/or meeting certain targets depending on a level of the member.

Embodiments of the system 200 may include a network of interconnected members of varying levels within a structure. Each level of the structure may be a medium of sharing. In the system 200, earning in each level of the structure may be different than other levels of the structure; users in the system 200 may earn an amount with respect to their levels of the structure. Embodiments of system 200 may include more than one structure. In the system 200, the plurality of members/users can sell their own products, help with selling one or more products available in the system 200 by displaying, sharing, etc. the product on their respective social networking platform, page or wall, and purchase the products being shared, displayed, offered for sale, and the like. Furthermore, each of the plurality of interconnected users may gain a specific earning over the sale of each product. Even though earning varies according to the quantity and amount of a sale, eventually everyone can acquire some profit or compensation. A member/user that is active and works in the system 200 may earn more compensation, rising to higher levels in the structure, and make the “American Dream” come true. Because earnings can be obtained from a sale of one or more product, a flow of income to the existing members may keep running even if no new members sign up for the system 200. Embodiments of system 200 may operate based on a company logic, algorithm, structure, guidelines, and the like, and may be implemented by a computing system 10, having a subscription system 25, a monitoring system 35, and a distribution system 45.

To get started, an individual or entity may join a host company platform by requesting to be a member. In other words, a processor of a computer system 10 may receive a request from a user to join the network, and then may then register the user as a member of the host company network. In an exemplary embodiment, a user may register with the host company by linking their social media accounts with the host company network, or they may register at the website of the host company over the Internet. A subscription system 25 of the computing system 10 may execute this step. Embodiments of the interconnected members may join, subscribe, etc. to the host company network 300, or platform, of system 200. Embodiments of a host company network 300 may be a collection of hardware components and computers interconnected by communication channels that allow sharing of resources and information, wherein more than one computer is interconnected through a communication media for information interchange. The host company network 300 may be embodied by a website hosted by at least one web server, wherein a subscription may be required to access some or all of the content of the host company website. One example of content of the host company website operated by the host company network is an online store, wherein the online retail store may offer for sale goods and services of various sellers sharing a business relationship with the host company. Embodiments of the online retail store may include a virtual store, an e-commerce shop, an e-shop, webs store, or any virtual space where goods and services may be purchased by a user over the Internet. Furthermore, the host company website may be connected, associated with, or in data communication with one or more social media networking sites, such as Facebook, Twitter, Google+, LinkedIn, Pinterest, MySpace, and the like. In one embodiment, the host company website may implement a software application configured to run on a computing device and cooperate with one or more social networking sites. In another embodiment, the host company website may require users/members to login to obtain the user's data from one or more social networking sites. Accordingly, the host company website may share or retrieve data with one or more social networking sites related to an individual user.

Referring still to FIG. 2, embodiments of system 200 may include a plurality of levels within a structure to determine an amount of compensation owed to the user/member attributed to sales of one or more products. After the processor of the computing system 10 receives a request from a user to join the network, the processor of computing system 10 may determine an appropriate level for the member within a structure. Each level of the structure has a certain number of users/members, and may be expected to invite and/or incorporate a certain number of new members to join the structure. Each structure within the system 200 may include a plurality of levels, wherein the structure has a first level, a second level, a third level, and a fourth level. However, those having skill in the art can appreciate that each structure may include more than four levels or less than four levels. Embodiments of the structure of system 200 may be exemplified by a tree, such as a sequoia tree, wherein the first level of the structure may be referred to a trunk, the second level may be referred to as a branch, the third level may be referred to as a twig, and the fourth level may be referred to as a leaf.

Embodiments of a first level member, or a trunk, within the structure may be appointed by the host company platform or network through a determining step of the processor of the computing system 10; the step of determining may be done in response the registration of the user to the host company network. For instance, a processor of computing system 10 may transmit a special invitation to a user of the system 200 subscribed to the host company network 300 to become a level one member of the structure. In other words, the step of determining, by a processor of a computing system 10, of an appropriate level of a user may include determining if the user can be invited, appointed, promoted, etc. to a level of the structure. In further embodiments, the computing system according to system 200 may invite appoint, promote, etc. a user to a level within the structure. The inviting, promoting, appointing etc., by the processor of the computing system 10, may be done in response to the determining, by the processor, if the user meets one or more requirements of the system 200 for acceptance into a particular level within the structure.

A first level member/user may be referred to as an executive of a company, having other members within the structure reporting to them. A first level member, or trunk, may generate a specific monthly income or compensation portion. In some embodiments, the specific monthly income may be a set quota that the trunk has to reach before being eliminated from the structure, or downgraded one or more levels within the structure. Moreover, the functions of a first level member, or trunk may be as follows:
Trunks are obliged to organize a team. Provided he/she is a candidate for Trunk invited by the host company, then he/she needs to incorporate a minimum number, such as 200, and a maximum number, such as 2000, new members into the system 200 with his/her team. But if he/she is to rise on his/her own will or step up through the system, then he/she needs to bring in a minimum number, such as 2000, new members to the system. The host company may, arbitrarily or through statistical and analytical determinations executed by computing system 10, increase or reduce the minimum and maximum numbers described above with respect to new members. Generally, trunks can follow up the activities of the people they have invited to the system. A first level member may be required to have at least two social media accounts and friends, and can support the people working within their structure and motivate them to let them achieve various targets, goals, and/or quotas. Moreover, trunks may share a number, such as 50, products which are automatically transmitted to their social media page by the host company. First level members may determine categories suitable to them, and pick up extra products and share them, thereby increasing their chance to sell. They are obliged to hold a minimum amount of meetings, such as twice a month, with the other members working under them within the structure via social media and share those meeting notes with the host company and/or a representative of the host company. They need to form a target group comprising a minimum number, such as, 200,000, of members as stated by the host company. Trunks have to reach a monthly turnover which is set as a minimum number of gross sales, such as USD 1 Million; the host company may raise or decrease the mentioned monthly turnover amount. They can check a sale amount actualized by the new members they have invited. They can spend efforts to increase the number of invitees of the people they have invited. Trunks may follow up how many products are sold and how much money is earned at any time attributed to a marketing team they have formed (e.g. Branches, Twigs, Leaves). They can study daily, weekly and monthly sales reports. Trunks can communicate with representatives and/or members of the host company, such as forwarding their weekly reports, wishes, opinions and questions. They may have a look at other Trunks' sales reports in the system and compete with them. By the end of the month, leader of the team actualizing the highest turnover becomes Trunk of the Month. He/she not only wins a Gold Medal for being the team leader of the month (This medal is placed next to his/her name and such medals demonstrate the Trunk's and his/her team's success within the host company) but also they may earn extra premiums and presents. If the new members they have invited (e.g. branches) are not active and show no performance at all, trunks can follow such branches, inform us about them and let them be removed from the system in addition to meeting with the host company team leader or representative to appoint a twig as a branch in a democratic manner. If trunks reach multiples of $1,000,000−($2.000.000-$3.000.000, etc.) set by the host company, then they will be entitled for an extra “bonus” besides premium. Bonuses may be 2.5% of the commission earning of the host company within the body of the trunk of that particular structure. In case the first level members cannot reach the sale amount in a number of months, such as 3 months, after they get involved in the system and cannot observe all requirements as necessitated by being a trunk, they will receive one or more warnings, such as two warnings, in writing (e-mail) via a representative of the host company, and unless they make a progress, they will be taken out of the system and replaced by one of their invitees among branches who will be co-opted as a trunk as a result of an election made among Branches. Trunks may earn one or more coupons in return for each transaction.

Embodiments of a second level member, or branch, may be appointed by the first level member, or trunk. For instance, the processor of a computer system 10 may receive an instruction from the first level member or the host company to identify a second user as a second level member. Embodiments of second level members may be referred to as sales managers appointed by the trunk. Second level members may be required to incorporate a minimum number, such as 50, and a maximum number, such as 500, new members, or “friends” into the system. Moreover, the functions of a second level member, or branch, may be as follows:
Second level members can follow up on the activities of the new members they have invited to the system. Second level members may be required to have friends included in at least two social media accounts. They must support the other members working under them in that particular structure (e.g. twigs) and motivate them to let them achieve their targets, goals, and/or quotas. They may share a plurality of products, such as 50 products, which are automatically transmitted to their social media page by the host company. In addition, they may determine categories suitable to them, and pick up extra products and share them, thereby increasing their chance to sell. They might have to reach a monthly turnover, which may set as a minimum amount, such as USD 5,000. The host company or users in a first level (e.g. trunks) may raise or decrease the mentioned target turnover amount. They can check the sale amount actualized by the new members they have invited. They can spend efforts to increase the number of invitees of the people they have invited. Branches may follow up how many products are sold and how much money is earned at any time thanks to the marketing team they have formed (e.g. Twigs, Leaves). They can study daily, weekly and monthly sales reports. They may have a look at other branches' sale reports in the system and compete with them. Second level members attaining the highest turnover by the end of the month becomes “Branch of the Month.” At the same time, the second level member may win a “Star Medal”; this medal is placed next to his/her name and all medals he/she has won demonstrate the branch's and his/her team's success within the system 200, giving him/her the opportunity to earn extra premiums and presents as well. If the new members they have invited (e.g. twigs) are not active and perform no transactions at all, branches can follow such twigs, inform us about them and let them be removed from the system in addition to meeting with the host company or communicating with a representative of the host company to appoint a leaf as a twig in a democratic manner. Users in the second level can receive one or more bonuses if they exceeds a target goal of sales. For example, if Branches quadruple a target, such as a $5,000 target set by the host company or user in the first level and reach $20.000, then they can be entitled for an extra “bonus” besides a premium. A bonus may be a percentage, such as 20%, of the commission earning of the host company within the body of that branch in that structure. In case the second level members cannot reach the sale in a certain number of months, such as 3 months, after they get involved in the system and cannot observe all requirements as necessitated by being a branch, they may receive one or more warnings, such as two warnings in writing (e-mail) via the host company or user within the first level and unless they make a progress, they can be taken out of the system and replaced by one of their invitees among twigs who can be co-opted as a branch as a result of an election made among twigs. The warnings may be auto-generated by the computing system 10. A second level member may earn one or more coupons in return for each transaction.

Embodiments of a third level member, such as a twig, may selected by a second level of a structure of the system 200. For instance, the processor of a computer system 10 may receive an instruction from the second or first level member to identify a third user as a third level member. Third level members may be required to incorporate a minimum number, such as 20, and a maximum number, such as 200, new members, or “friends” into the system. Moreover, the functions of a third level member, or twig, may be as follows:
Third level members can follow up the activities of the people they have invited in the system. They can support the other members working under them (e.g. leaves) and motivate them to let them achieve their targets, goals, and/or quotas. Third level members may share a plurality of products, such as 50 products, which are automatically transmitted to their social media page by the host company. In addition, they may determine categories suitable to them, and pick up extra products and share them, thereby increasing their chance to sell. They have to reach a monthly turnover which may be set as a minimum amount, such as USD 150; the host company may raise or decrease the mentioned target turnover amount. They can check the monthly sale amount actualized by the new members they have invited. They can spend efforts to increase the number of invitees of the people they have invited. Twigs may follow up how many products are sold and how much money is earned at any time attributed to the marketing team they have formed (e.g. leaves). They can study daily, weekly and monthly sales reports. They may have a look at other twigs' sale reports in the system and compete with them. A twig attaining the highest turnover by the end of the month wins the “twig medal” as “Twig of the Month.” The medal is placed next to his/her name and all medals he/she has won demonstrate the twig's and his/her team's success within the structure. Provided that twigs attain a sale amounting to a target level, such as $5,000, three times in six months, they are automatically upgraded to “branch” or second level. In case third level members cannot reach the sale amount in a certain number of months, such as 3 months, after they get involved in the system and cannot observe all requirements as necessitated by being a twig, they may receive one or more warnings, such as two warnings in writing (email) via the host company, and unless they make a progress, they will be taken out of the system and replaced by one of their invited leaves who will be co-opted as a “twig” as a result of an election made among leaves. A third level member may earn one or more coupons in return for each transaction.

Embodiments of a fourth level member, or leaf, may be selected by the first, second, or third level member. For instance, the processor of a computer system 10 may receive an instruction from the third level member to identify a fourth user as a fourth level member. Moreover, the functions of a fourth level member, or leaf, may be as follows:
Fourth level members are ranked at the bottom, and may invite new member, such as “friends” to the system. They may control their earnings. They become entitled for the Coupon draw according to the amount of sale actualized through them. Leaves can obtain their earnings from the lottery of the trunk under which they operate within that structure, and may step up in the system. If any leaf makes more than a certain number of friends or new members, such as 200 friends, under its body or actualizes an amount of earnings or sales, such as $150 sale, for 3 months in succession, then the fourth level member may be appointed as “twig” by the host company. A fourth level member may earn one or more coupons in return for each transaction.

Referring back to FIGS. 1A-2, embodiments of the method 100, 500 and system 200 may determine an amount of proceeds to be distributed to the members of the structure and the host company. Proceeds may be distributed to a member/user based on a level of the member within a structure, and may be distributed to the host company according to a fixed percentage of earnings based on sales of products associated with the sharing, displaying, selling, purchasing, etc. of products throughout the social media networking sites supporting the system 200. To generate earnings, members of the system 200 may share, display, sell, purchase, etc. a particular product being sold by a partner (seller) of the host company or the host company. A product offered by a particular company sharing a business relationship with the host company may be made available on a user's individual social networking platform or “page.” For instance, a first level member may allow an advertisement on their personal Facebook page or “wall”, and if a “friend” sees the advertisement and clicks on the advertisement and ultimately purchases the product, a sale is made and proceeds are distributed accordingly. However, if a first level member invites a new member to the system 200, and the new member also allows/displays the advertisement on their page or wall, and a “friend” of the new member clicks on the advertisement and a sale is ultimately made, proceeds are distributed to each of the host company, first level member, and their newly recruited member. As mentioned above, the first level member, the trunk, incorporates a minimum number of new members (e.g. 200), and exposure of the product being displayed/advertised has greatly increased because it is now available on a large number of member's Facebook page, or other social networking platform. The first level member is motivated to recruit new members because they receive a portion of the proceeds of a sale occurring from exposure on a recruit's page, and the new recruit is motivated to join the host company network 300 and display the product being sold because they too receive a portion of the proceeds. As described above, the recruits of the first level member may be appointed as a second level member, and may recruit new members to expand their network, and recruit third level members. Essentially, embodiments of system 200 incorporates “wall-to-wall” marketing of a plurality of products, and everyone in between may receive a portion of the earnings from the sales of the plurality of products. As an example, if a particular structure has 1,000 structures, the plurality of products may be displayed on a 1,000,000 “walls” of interconnected users/members.

The company or individual providing the product for sale and the host company receive an amount, of gross proceeds, and the host company distributes the remaining portion of the sale proceeds associated with that particular product to the members of the host company network 300 of system 200 involved and/or related to the transaction. Specifically, embodiments of method 100 may include the step of distributing, by the processor of the computing system, a remaining amount of proceeds to the first user and the second user in accordance with the level of the first user and the level of the second user within the structure. The gross amount of proceeds generated by a sale of a product advertised on a social media platform of the first user and a social media platform of the second user may be distributed to a seller of the product and to the host company network, wherein a larger amount of the gross proceeds may be distributed to the seller than the host company network. For example, if Company A contracts with the host company to sell/advertise Product X, the members subscribed to the host company network 300 may display, share, advertise, purchase, etc. Product X on their personal social networking sites, which exposes all visitors of their page/wall to Product X. Computing system 10, in accordance with host company network 300, may determine what products to display or advertise on a particular user's platform. The determination may be made based on a plurality of factors relating to the user; the factors may be personal information found on the user's social networking/media profile, wall, and include their activity on one or more social media networking sites. The information retrieved by system 200 may include information about other users of the social media networking site that interact with the user member of the host company network. In response to the determination, the computing system 10 of the host company may place, insert, display, add, etc., an online advertisement to a particular product that is being sold by a seller who shares a business relationship with the host company. In other embodiments, the computing system 10 may place online advertisement for a given product on a user's social networking platform based on a random determination, case-by-case determination, static demographics, such as age of the use, gender of the user, etc., or by user request to display/advertise/showcase a particular type of product. In further embodiments, the social networking site where one or products can be displayed, advertised, or otherwise made available for a visitor to the page to click on the image or link, may be a page/wall/profile space of an individual, a business, movie studio, celebrity, cartoon character, brand, music group, a fictitious person, and the like.

Once the online advertisement is placed onto the user's “wall,” anyone (e.g. buyer) having access to the user's “wall” may click on the online advertisement, which can route, direct, or potentially redirect the buyer to the product being sold through the host company website (e.g. online retail store). If the buyer purchases the product based on the clickthrough from the user's social media page, then the proceeds may be distributed to one or members of the host company network, the host company, and the seller, wherein the portions may be a percentage of the total proceeds generated from the sale. For instance, each sale of Product X generates a total amount of proceeds to be distributed; the monitoring system 35 of the computing system 10 may implement the monitoring, tracking, storing, calculating of the total sales. Company A (seller) may receive a portion, such as 80%, of the total amount of proceeds generated by the sale of Product X, while the host company may receive the remaining portion, such as 20%, of the total proceeds generated by the sale of Product X. Then, the host company may distribute a portion, such as 90%, of the remaining portion distributed to the host company (20%) to the member(s) of system 200 that were involved and/related to the sale of Product X. The distribution of the member portion or user portion may be distributed according to the levels of membership of the structure. The distribution of the proceeds may be implemented by the distribution system 45 of the computing system 10. The distribution system 45 may distribute, deposit, allocate, dispense, issue, deliver, and disperse, etc., funds, points, payment, value, currency, and the like, according to their level within the structure. Each level in the structure may have a compensation package or percentage of distributable proceeds received by the host company network. Embodiments of the distribution system 45 may deposit funds into an electronic user account; the user account may function as an internal bank account, or virtual wallet, that may collect and store an accumulated currency. Other embodiments of the distribution system 45 may deposit funds into an external bank account owned by the user using known techniques such as utilizing an account number and routing number of the user's bank account affiliated with an external bank or similar financial institution. Further embodiments of the distribution system 45 include collecting and storing payment information on a storage device 14 or a database 12 of computing system 10 to track and record payment information to the user and/or website.

The following examples are meant to provide exemplary embodiments of how the proceeds are distributed to members/users according to their level within the structure, in accordance with the system 200 and method 100, 500.

### Example 1

Earning Breakdown in the System - total amount of proceeds
generated by a sale of a product of $1,000,000

| | Sale - | | Commission |
|---|---|---|---|
| | Commission | Commission | amount |
| Seller | Amount (US $) | rate | (US $) |
| Trunk Sales in structure | 1,000,000 | 20% | 200,000 |
| Host company Commission | | 10% | 20,000 |
| Commission to be | | | 180,000 |
| distributed | | | |

Breakdown of Commission to be distributed - $180,000

| | % of | Amount per | Number of | Amount per |
|---|---|---|---|---|
| | Commission | Unit | Persons to Share | Individual |
| Trunk | 0.003 | 540 | 1 | 540 |
| Branch | 0.13 | 23,400 | 200 | 117 |
| Twig | 0.40 | 72,000 | 10,000 | 720 |
| Leaf | 0.467 | 84,060 | 200,000 | Lotto |
| | | | | distribution |

Leaves' Lotto Distribution - US$84,060

| Number of | | | Amount to be |
|---|---|---|---|
| persons | % rate | Lotto per Person | distributed |
| 200 | 20% | 84.06 | 16,812 |
| 2,000 | 30% | 12.60 | 25,218 |
| 20,000 | 30% | 1.26 | 25,218 |
| 177,800 | 20% | 0.094 | 16,812 |
| | | Total | 84,060 |

### Example 2

Earning Breakdown in the System - total amount of proceeds
generated by a sale of a product of $4,000,000

| | Sale- | | Commission |
|---|---|---|---|
| | Commission | Commission | amount |
| Seller | Amount (US $) | rate | (US $) |
| Trunk Sales | 4,000,000 | 20% | 800,000 |
| Go Get Sale Commission | | 7.75% | 62,000 |
| Go get Sale Commission - | | 2.25% | 18,000 |
| Bonus transfer | | | |

| | |
|---|---|
| Commission to be distributed | 720,000 |
| Total Commission to be distributed | 738,000 |

The host company may transfer $18,000 out of its commission earning of $80,000 to be distributed as a bonus to members of the host company network 300

Breakdown of US$738.000 Commission

| | | Amount -t | No. of | Amount of | Bonus | Total | Total |
|---|---|---|---|---|---|---|---|
| | % of | per | Persons | $ per | amount, | earnings | bonus |
| | Commission | Unit | to share | Individual | $ | $ | distributed |
| Trunk | 0.003 | 2,160 | 1 | 2,160 | 2,000 | 4,160 | 4,160 |
| $4,000,000 | | | | | | | |
| Branch | 0.13 | 93,600 | 200 | 468 | 80 | 548 | 109,600 |
| $20,000 | | | | | | | |
| Twig | 0.40 | 288,000 | 10,000 | 28.80 | | 28.8 | 288,000 |
| $400 | | | | | | | |
| Leaf | 0.467 | 336,240 | 200,000 | Lotto | | | 336,240 |
| | | | | distribution | | | |
| | | | | | | Total | 738,000 |

Leaves' Lotto Distribution of US$336,240

| | | | Amount to be |
|---|---|---|---|
| Number of persons | % rate | Lotto per Person | distributed |
| 200 | %20 | 336.24 | 67,248 |
| 2,000 | %30 | 50.43 | 100,872 |
| 20,000 | %30 | 5.04 | 100,872 |
| 177,800 | %20 | 0.37 | 67,248 |
| | | Total | 336,240 |

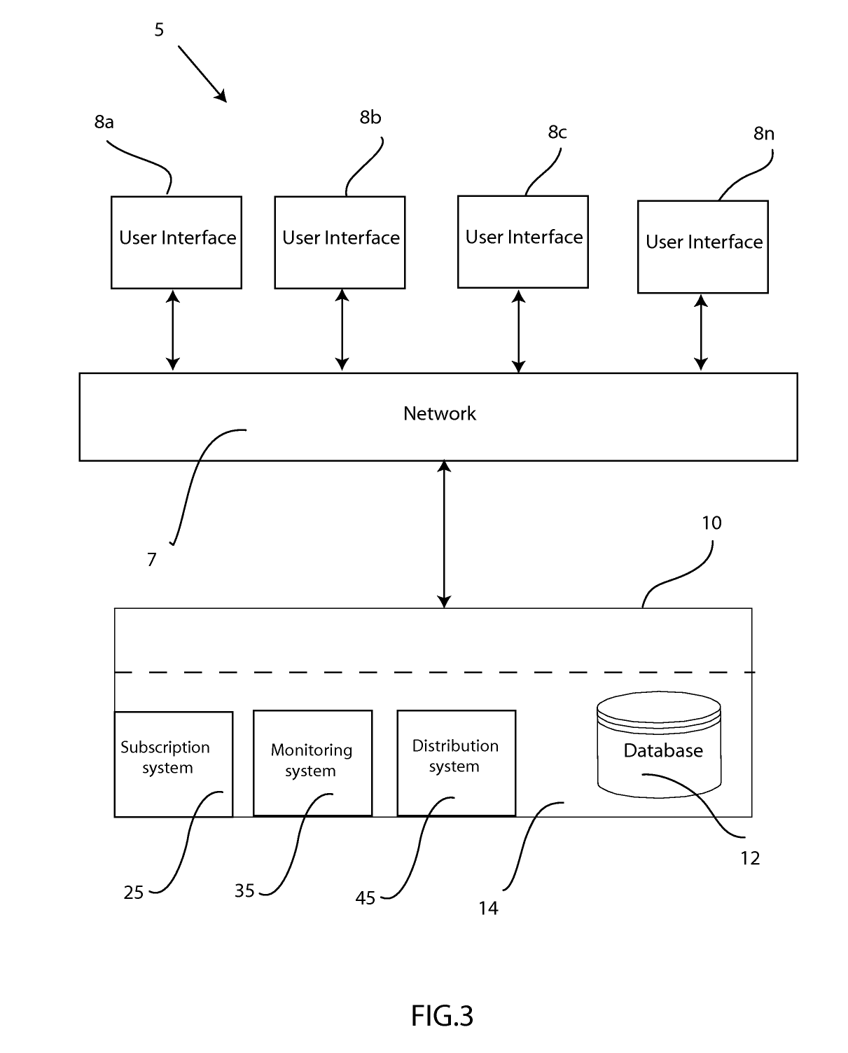

Referring now to FIG. 3, an embodiment of system 5 may be used to implement a method of proceed distribution to a plurality of interconnected users 100, 500. System 5 may receive a request to join or subscribe a host company network from a first user. System 5 may determine a level of the first user, or identify the first user as a first level member; the level of the first user may also be stored on a database 12 of system 5. System 5 may then receive a request from the first user, now a member of the host company network, to identify a second user as a second level member. Likewise, system 5 may receive a request from the second user to identify a third user as a third level member, and may also receive a request from the third user to identify a fourth user as a fourth level member. Moreover, system 5 may track, monitor, and store the amount(s) of proceeds generating from a sale of a product that was shared by at least one of the first user, the second user, the third user, and the fourth user. System 5 may then determine an appropriate amount of proceeds to be distributed to the host company, the seller of the product, the plurality of users/members subscribed to the host company network. After determining the amount of proceeds to be generated to each party, system 5 may allocate the proceeds electronically to various accounts of the host company, the seller, and the plurality of users.

System 5 may comprise user interfaces 8a . . . 8n connected through a network 7 to a computing system 10, wherein the computing system 10 includes an subscription system 25, a monitoring system 35, and a distribution system 45. Network 7 may comprise any type of network including, inter alia, a telephone network, a cellular telephone network, a local area network, (LAN), a wide area network (WAN), the Internet, etc. User interfaces 8a . . . 8n may comprise any type of devices capable of implementing a network (e.g. social network) including, inter alia, a telephone, a cellular telephone, a digital assistant (PDA), a smart phone, a video game system, an audio/video player, a personal computer, a laptop computer, a desktop computer, a computer terminal, etc. Each of user interfaces 8a . . . 8n may comprise a single device or a plurality of devices. User interfaces 8a . . . 8n are used by end users for communicating with each other and computing system 10. For example, users may use the user interfaces 8a . . . 8n to subscribe or join the host company network by communication with a processor 491. Additionally, users may input data, such as personal, user account information, payment plans, customized instructions, and other data associated with the method 100, 500. Computing system 10 may comprise any type of computing system(s) including, inter alia, a personal computer (PC), a server computer, a database computer, etc. Computing system 10 may be executing the host company network 300. For example, a processor 491 of the computing system 10 may be executing software performing steps associated with method 100, 500. Moreover, computing system 10 may be used to monitor and track sales over network 7, such as a sale of a product shared on an individual member's social networking wall. Computing system 10 may comprise a memory system 14. Memory system 14, or computer readable storage device, may comprise a single memory system. Alternatively, memory system 14 may comprise a plurality of memory systems. Memory system 14 may also comprise a software application and a database 12. Database 12 may include all retrieved and calculated data associated with subscription, monitoring, tracking, distributing, and other the steps associated with method 100, 500. Database 12 may be internal to the computing system 10 and/or memory device 14 as depicted in FIG. 2. Alternatively, database 12 may be external to the computing system 10. Moreover, the subscription system 25, the monitoring system 35, and the distribution system 45 may be internal or external to the computing system 10. In one embodiment, the subscription system 25, the monitoring system 35, and the distribution system 45 may be modules in a software application that can enable a method 100, 500. In another embodiment, the subscription system 25, the monitoring system 35, and the distribution system 45 may be independent software applications or part of the same software application that can enable method 100, 500. In yet another embodiment, the subscription system 25, the monitoring system 35, and the distribution system 45 may each have its own processor in a computing system 10, or may be part of the computing system 10, as shown in FIG. 3.

With reference to FIG. 4, an embodiment of a computer apparatus 490, such as computing system 10 of FIG. 3 used for executing a subscription, monitoring, and distribution system and method, is now described. The computer system 490 comprises a processor 491, an input device 492 coupled to the processor 491, an output device 493 coupled to the processor 491, and memory devices 494 and 495 each coupled to the processor 491. The processor 491 (of computing system 10) may execute the subscription system 25, monitoring system 35, and the distribution system 45. Moreover, the processor 491 may be a single processor executing the subscription system 25, monitoring system 35, and the distribution system 45, or may be more than independent processor executing the subscription system 25, monitoring system 35, and the distribution system 45. The input device 492 may be, inter alia, a keyboard, a software application, a mouse, etc. The output device 493 may be, inter alia, a printer, a plotter, a computer screen, a magnetic tape, a removable hard disk, a floppy disk, a software application, etc. The memory devices 494 and 495 may be, inter alia, a hard disk, a floppy disk, a magnetic tape, an optical storage such as a compact disc (CD) or a digital video disc (DVD), a dynamic random access memory (DRAM), a read-only memory (ROM), etc. The memory device 495 includes a computer code 497. The computer code 497 includes algorithms or steps (e.g., the algorithms and/or steps of FIGS. 1-4) for method 100, 500. The processor 491 executes the computer code 497. The memory device 494 includes input data 496. The input data 496 includes input required by the computer code 497. The output device 493 displays output from the computer code 497. Either or both memory devices 494 and 495 (or one or more additional memory devices not shown in FIG. 4) may comprise the algorithms and/or steps of FIGS. 1-2 and may be used as a computer usable medium (or a computer readable medium or a program storage device) having a computer readable program code embodied therein and/or having other data stored therein, wherein the computer readable program code comprises the computer code 497. Generally, a computer program product (or, alternatively, an article of manufacture) of the computer system 490 may comprise the computer usable medium (or said program storage device). While FIG. 4 shows the computer system 490 as a particular configuration of hardware and software, any configuration of hardware and software, as would be known to a person of ordinary skill in the art, may be utilized for the purposes stated supra in conjunction with the particular computer system 490. For example, the memory devices 494 and 495 may be portions of a single memory device rather than separate memory devices. Therefore, computing system 10, including the subscription system 25, the monitoring system 35, and the distribution system 45, can enable a computer-implemented method 100, 500.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the invention, as required by the following claims. The claims provide the scope of the coverage of the invention and cannot be limited to the specific examples provided herein.

1. A method comprising:
registering, by a processor of a computing system, a first user based on a request to join a host company network;
determining, by the processor of the computing system, a level of the first user within a structure of the host company network;
registering, by the processor of the computing system, a second user with the host company network, based on an invitation from the first user to the second user to join the host company network, wherein a level of the second user in the structure is different than the level of the first user;
tracking, by the processor of the computing system, a gross amount of proceeds generated by a sale of a product advertised on a social media platform of the first user and a social media platform of the second user; and
distributing, by the processor of the computing system, a remaining amount of proceeds to the first user and the second user in accordance with the level of the first user and the level of the second user within the structure.

2. The method of claim 1, wherein the gross amount of proceeds generated by a sale of a product advertised on the social media platform of the first user and the social media platform of the second user is distributed to a seller of the product and to the host company network, wherein a larger amount of the gross proceeds are distributed to the seller than the host company network.

3. The method of claim 2, wherein the remaining amount of proceeds is a portion of the gross amount of proceeds received by the host company network.

4. The method of claim 2, wherein the seller shares a business relationship with the host company network.

5. The method of claim 1, wherein the sale of the product occurs through a website operated by the host company network.

6. The method of claim 1, wherein the level of the first user earns a higher percentage of the remaining amount of proceeds than the level of the second user.

7. The method of claim 1, wherein the social media platform is a personal profile space of at least one of the first user and the second user, located on a website and accessible over the Internet.

8. The method of claim 1, wherein the step of tracking includes calculating, by the processor of the computing system, the gross proceeds generated by the sale of the product.

9. The method of claim 1, further comprising:
registering, by the processor of a computing system, a third user with the host company network, based on an invitation from at least one of the first user and the second user to join the host company network, wherein a level of the third user in the structure depends on a level of the inviting party within the structure.

10. A method of social networking advertising and proceed distribution comprising:
establishing an online retail store operated by a host company network, the host company network implemented by a processor of a computing system;
receiving, by the processor of the computing system, a request for membership to join the host company network from a plurality of users;
in response to receiving the request, determining, by the processor of the computing system, a level of membership of the plurality of users within one or more structures;
placing, by the processor of a computing system, an online advertisement of a product being sold on the online retail store operated by the host company network on a social networking platform of one or more of the plurality of users; and
distributing, by the processor of a computing system, an amount of proceeds to one or more users of the plurality of users in response to a sale of the product at the online retail store of the host company network.

11. The method of claim 10, wherein the amount of proceeds are only distributed to the one or more users of the plurality of users if a buyer interacted with the online advertisement placed on the social networking platform of the one or more users.

12. The method of claim 10, wherein the product is a good or a service.

13. The method of claim 10, wherein the social networking platform is a personal profile space of the plurality of users, located on a website and accessible over the Internet.

14. The method of claim 10, further comprising:
selecting, by the processor of the computing system, the product to be advertised through placement of the online advertisement on the social networking platform based on information gathered from the social networking platform of the plurality of users.

15. The method of claim 14, wherein the information gathered includes personal information about users who interact with the member on the social networking platform over the Internet.

16. A computing system comprising a computer processor coupled to a computer-readable storage device, said storage device containing instructions that when executed by the processor implements a method comprising:
registering, by a processor of a computing system, a first user based on a request to join a host company network;
determining, by the processor of the computing system, a level of the first user within a structure of the host company network;
registering, by the processor of the computing system, a second user with the host company network, based on an invitation from the first user to the second user to join the host company network, wherein a level of the second user within the structure is below the level of the first user;
tracking, by the processor of the computing system, a gross amount of proceeds generated by a sale of a product advertised on a social media platform of the first user and a social media platform of the second user; and
distributing, by the processor of the computing system, a remaining amount of proceeds to the first user and the second user in accordance with the level of the first user and the level of the second user within the structure.

17. The computing system of claim 16, wherein the gross amount of proceeds generated by a sale of a product advertised on the social media platform of the first user and the social media platform of the second user is distributed to a seller of the product and to the host company network, wherein a larger amount of the gross proceeds are distributed to the seller than the host company network, wherein the remaining amount of proceeds is a portion of the gross amount of proceeds received by the host company network.

18. The computing system of claim 16, wherein the sale of the product occurs through a website operated by the host company network.

19. The computing system of claim 16, wherein the social media platform is a personal profile space of at least one of the first user and the second user, located on a website and accessible over the Internet.

20. The computing system of claim 16, further comprising:
registering, by the processor of a computing system, a third user with the host company network, based on an invitation from at least one of the first user and the second user to join the host company network, wherein a level of the third user in the structure depends on a level of the inviting party within the structure.
